(19) United States
(12) Patent Application Publication
(10) Pub. No.: US 2026/0329530 A1
(43) Pub. Date: Oct. 22, 2026

(54) FLOATING-POINT ADDITION AND SUBTRACTION CIRCUIT DEVICE

(71) Applicant: FlashSilicon Incorporation, Diamond Bar, CA (US)

(72) Inventors: Lee Wang, Diamond Bar, CA (US); Xiang Su, Shanghai (CN); YanZhen Wang, Shanghai (CN); MengDong Xu, Shanghai (CN)

(21) Appl. No.: 19/206,486

(22) Filed: May 13, 2025

(30) Foreign Application Priority Data
Apr. 18, 2025 (CN) 202510497114.X

(51) Int. Cl. G06F 7/485; G06F 5/01

(52) U.S. Cl. CPC G06F 7/485; G06F 5/012

(57) ABSTRACT

A floating-point arithmetic device for two floating-point number operands is disclosed. The device comprises an exponent subtraction circuit, an exponent computation circuit, a mantissa computation circuit and a conversion circuit. The exponent subtraction circuit produces a sign bit and an exponent difference according a difference between the exponents of the two operands. The exponent computation circuit produces the after-operation exponent bits according to a larger number of the exponents of the two operands. The mantissa computation circuit aligns mantissa bits for the two operands and then performs one of addition and subtraction operation on the aligned mantissas. For better computation efficiency and less power consumption, the floating-point arithmetic device can perform one step (one clock) floating-point addition or subtraction operation without moving the intermediate floating point number data in and out of registers and various functional circuit units as in the multiple step operations.

### FIELD OF THE INVENTION

The invention is related to a floating-point addition and subtraction circuit device. In particular, for better computation efficiency with less power consumption, the addition and subtraction circuit device of the invention operates in one-step floating-point addition/subtraction without moving the intermediate data in and out of memory and arithmetical circuit units as in the multiple-step operations. To achieve the one-step floating-point addition/subtraction operation, the floating-point addition and subtraction circuit device of the invention comprises: (1) a circuit to convert two inputted operand codes in the IEEE 754 floating-point format into the full floating-point binary representation to include the two most significant mantissa bits; (2) a circuit to align the operand mantissa bits accordingly with the exponent difference of the two operand codes; (3) a circuit for the aligned mantissa bits performing addition/subtraction operation and a circuit for the sign bit operation; (4) a circuit for converting the resultant binary code back to the IEEE 754 floating-point number code format ready for further arithmetic operations or storage in memory.

### DESCRIPTION OF THE RELATED ART

In digital computing systems numbers are represented in the binary formats.

For example, an integer number A in the m-bit binary format is given by

A=aₘ₋₁2^{m-1}+aₘ₋₂2^{m-2}+. . . +a₁2¹+a₀=(aₘ₋₁aₘ₋₂. . . a₁a₀)b,

where aᵢ=[0, 1] for i=0, . . . , (m−1), and the symbol “b” indicates the integer number A in the binary format. For the binary addition/subtraction operation with another m-bit integer number

B=bₘ₋₁2^{m-1}+bₘ₋₂2^{m-2}+. . . +b₁2¹+b₀=(bₘ₋₁bₘ₋₂. . . b₁b₀)b

where bᵢ=[0, 1] for i=0, . . . , (m−1).

The resultant number

C=A±B=(aₘ₋₁±bₘ₋₁)2^{m-1}+(aₘ₋₂±bₘ₋₂)2^{m-2}+. . . +(a₁±b₁)2¹+(a₀±b₀)2⁰=(cₘsₘ₋₁. . . s₁s₀)b.

For each bit of operation, i.e., (aₖ±bₖ) for k 0, . . . , (m−1), the output can be written by the sum bit sₖ and the carry-over bit cₖ to the next higher significant bit. Note that the most significant carry-over bit cₘ indicates the carry-over bit for m-bit addition and sg denotes the negation bit for the m-bit subtraction as shown in FIG. 1. The binary number sₖ and cₖ₊₁ for bit-bit addition/subtraction are constructed with the combinational logic gate circuit 110 comprising a full adder 112 and an XOR gate 111. Accordingly the addition/subtraction circuit 100 for two m-bit integer numbers is configured in FIG. 1. The m-bit binary integer addition/subtraction circuit 100 comprises a m-bit addition/subtraction circuit 11 (“m” units of sub-circuit 110) in the first row, a 2's complement conversion circuit 12 in the second row and a logic circuit 13 in FIG. 1. Meanwhile the voltage signal Sub at node 101 with V_{SS} (logic “0”) and V_{DD} (logic “1”) indicates the addition operation for C=A+B and the subtraction operation for C=A−B, respectively. The logic circuit 13 according to the inputted voltage signals at node 101 for Sub and the carry-over bit voltage signals at node 102 for c′ₘ from the “m” bit-bit addition/subtraction circuit 11 generates the sign signals for sg at node 103 (“V_{DD}” for the negation bit “1”) for subtraction operation and the carry-over signals for cₘ at node 104 (“V_{DD}” for the carry-over bit “1”) for addition operation. It is straightforward to verify the correctness of the addition and subtraction operation for the two m-bit binary integer number A and B by verifying the voltage signals for the logic values of the bit-bit operational sub-circuits in 11 and 12 in FIG. 1.

Besides the integer numbers represented by the “m-bit” binary format in number computation, the floating-point number representation is introduced to expand the computational dynamic range for a fixed number of bit length in computer systems. According to IEEE 754 binary floating-point number code format, a binary floating-point number A is represented by one sign bit sa, a q-bit exponent ea, and a p-bit mantissa a, that is,

$$A = {( - )}^{s a} {2}^{e a} ( {a}_{p - 1} + {a}_{p - 2} \frac{1}{{2}^{1}} + … + {a}_{1} \frac{1}{{2}^{p - 2}} + {a}_{0} \frac{1}{{2}^{p - 1}} )$$

$$≡ ( sa {ea}_{q - 1} e {a}_{q - 2} … {ea}_{1} e {a}_{0} {a}_{p - 1} {a}_{p - 2} … {a}_{1} {a}_{0} ) f ,$$

$$with$$

$$ea = ( e {a}_{q - 1} {2}^{q - 1} + e {a}_{q - 2} {2}^{q - 2} + … + e {a}_{1} {2}^{1} + e {a}_{0} {2}^{0} ) - {2}^{q - 1} + 1 ,$$

$$and$$

$$a = {a}_{p - 1} + {a}_{p - 2} \frac{1}{{2}^{1}} + … + {a}_{1} \frac{1}{{2}^{p - 2}} + {a}_{0} \frac{1}{{2}^{p - 1}} ,$$

where the binary numbers sa, eaᵢ, aⱼ=[0, 1] for i=0, . . . , (q−1) and j=0, . . . , (p−1), and f indicates the floating-point binary representation. Note that since the binary values of aₚ₋₁=“0” for every eaᵢ=“0” and i=0, . . . , (q−1) representing the subnormal floating-point numbers and aₚ₋₁=“I” for any non-zero eaᵢ=“1” and i=0, . . . , (q−1) representing the normal floating-point numbers can be decoded from the exponent bits eaᵢ for i=0, . . . , (q−1), a floating-point number code is usually stored and transported without the Most Significant Bit (MSB) aₚ₋₁ of the mantissa. Therefore, the total number of bits stored and transported still remains (p+q) bits for the floating-point number code in IEEE 754 format. For example, in computing systems, the floating-point 8 is (p+q)=8 bits, the half precision is (p+q)=16 bits, the single precision is (p+q)=32 bits, the double precision is (p+q)=64 bits, the quadruple precision is (p+q)=128 bits, and the octuple precision is (p+q)=256 bits, and so forth. Floating-point decoders in the computing hardware are always to decode the binary value of the MSB aₚ₋₁ for the p^{th}-bit mantissa from the q-bit exponent (ea_{q-1} . . . ea₀)b in IEEE 754 format prior to binary arithmetic operations.

For the same format as the floating-point number A, a floating-point number B with one sign bit sb, a q-bit exponent bits eb, and a p-bit mantissa b is given by

$$B = {( - )}^{s b} {2}^{e b} ( {b}_{p - 1} + {b}_{p - 2} \frac{1}{{2}^{1}} + … + {b}_{1} \frac{1}{{2}^{p - 2}} + {b}_{0} \frac{1}{{2}^{p - 1}} )$$

$$≡ ( sb e {b}_{q - 1} , … {eb}_{0} {b}_{p - 1} {b}_{p - 2} … {b}_{1} {b}_{0} ) f ,$$

$$with$$

$$eb = ( e {b}_{q - 1} {2}^{q - 1} + e {b}_{q - 2} {2}^{q - 2} + … + e {b}_{1} {2}^{1} + e {b}_{0} {2}^{0} ) - {2}^{q - 1} + 1 ,$$

$$and$$

$$b = {b}_{p - 1} + {b}_{p - 2} \frac{1}{{2}^{1}} + … + {b}_{1} \frac{1}{{2}^{p - 2}} + {b}_{0} \frac{1}{{2}^{p - 1}} ,$$

where the binary numbers sb, ebᵢ, b, [0, 1] for i=0, . . . , (q−1) and j=0, . . . , (p−1), and f indicates the floating-point binary representation. Accordingly, the floating-point number C for the addition/subtraction of A and B, i. e., C=A±B, is then given by

$$C = A \pm B = {( - )}^{s a} {2}^{e a} ( {a}_{p - 1} \frac{1}{{2}^{0}} + {a}_{p - 2} \frac{1}{{2}^{1}} + … + {a}_{1} \frac{1}{{2}^{p - 2}} + {a}_{0} \frac{1}{{2}^{p - 1}} ) \pm$$

$${( - )}^{s b} {2}^{e b} ( {b}_{p - 1} \frac{1}{{2}^{0}} + {b}_{p - 2} \frac{1}{{2}^{1}} + … + {b}_{1} \frac{1}{{2}^{p - 2}} + {b}_{0} \frac{1}{{2}^{p - 1}} ) .$$

As we can see from the above equation, the resultant floating-point number C cannot be simply obtained from the bit-bit operation for each mantissa bit of A not aligned with each mantissa bit of B for ea≠eb. To obtain the correct floating-point number and avoid the fault situations such as A+B≠B+A and A−B≠−(B−A), the operand exponents need to be adjusted to the same exponent with the aligned number's mantissas for the addition/subtraction operation to take place correctly in this invention.

For the main aspect of this invention, the addition and subtraction circuit device is designed to carry out the addition/subtraction operation in one operational step for two floating-point numbers represented by a floating-point format to output the resultant floating-point number also represented by the same floating-point format. In contrast, the conventional floating-point number addition/subtraction circuit device with the multiple operational steps usually involves intermediate data transportation through bus-lines between temporary data memory storage circuits and other logic circuits such as the comparison circuit and the shifting circuits. Therefore for the one-step operation, the computation efficiency can be greatly enhanced with the invented addition and subtraction circuit device due to no intermediate data transportation and temporal memory storage.

In another aspect of this invention, since no intermediate data transportation between memory circuits and other operational circuits occurs, the power consumption for intermediate data transportation through the connecting bus-lines between circuit blocks can be totally saved. The power consumption for data transportation through a fixed bandwidth of bus-lines is considered to be the major factor for the power consumption of digital computational systems.

In another aspect of this invention, when the resultant floating-point number obtained from the circuit operation is non-representable with finite bit length of floating-point number format such as IEEE 754, the overflow flag signal shall be generated from the operational circuit to indicate the resultant number is out of the numeric representation range. The out of range floating-point number cannot be applied for further arithmetic operation and memory storage to prevent the computation error for the same finite bit length of floating-point number representation.

In another aspect of this invention, since the input/output floating-point numbers of the invented addition and subtraction circuit device are all in the same floating-point format as the complete piece of numerical elements for the data transportation and memory storage in computer systems, the data management for the complete numerical elements of arithmetical operations and memory assessing can be easier to handle such that the addition/subtraction circuit device of the invention can be efficiently applied to the matrix computations specially for the neural network model computation in Machine Learning (ML) as scaling up for a large model systems.

### SUMMARY OF THE INVENTION

The equation for the floating-point addition/subtraction operation can be written by

$$C = A \pm B = {( - )}^{s a} {2}^{e a} ( {a}_{p - 1} \frac{1}{{2}^{0}} + {a}_{p - 2} \frac{1}{{2}^{1}} + … + {a}_{1} \frac{1}{{2}^{p - 2}} + {a}_{0} \frac{1}{{2}^{p - 1}} ) \pm$$

$${( - )}^{s b} {2}^{e b} ( {b}_{p - 1} \frac{1}{{2}^{0}} + {b}_{p - 2} \frac{1}{{2}^{1}} + … + \frac{1}{{2}^{p - 2}} + {b}_{0} \frac{1}{{2}^{p - 1}} ) ,$$

and further rewritten as

$$= {( - )}^{s a} {2}^{e a} [ ( {a}_{p - 1} \frac{1}{{2}^{0}} + {a}_{p - 2} \frac{1}{{2}^{1}} + … + {a}_{1} \frac{1}{{2}^{p - 2}} + {a}_{0} \frac{1}{{2}^{p - 1}} ) \pm$$

$${( - )}^{s b - s a} ( {b}_{p - 1} \frac{1}{{2}^{e d}} + {b}_{p - 2} \frac{1}{{2}^{1 + e d}} + … + {b}_{1} \frac{1}{{2}^{p - 2 + e d}} + {b}_{0} \frac{1}{{2}^{p - 1 + ed}} ) ] ,$$

$$for ed \geq 0$$

$$and$$

$$= {( - )}^{s a} {2}^{e b} [ ( {a}_{p - 1} \frac{1}{{2}^{- e d}} + {a}_{p - 2} \frac{1}{{2}^{1 - e d}} + … + {a}_{1} \frac{1}{{2}^{p - 2 - e d}} + {a}_{0} \frac{1}{{2}^{p - 1 - e d}} ) \pm$$

$${( - )}^{s b - s a} ( {b}_{p - 1} \frac{1}{{2}^{0}} + {b}_{p - 2} \frac{1}{{2}^{1}} + … + {b}_{1} \frac{1}{{2}^{P - 2}} + {b}_{0} \frac{1}{{2}^{P - 2}} ) ] ,$$

$$for ed < 0 ,$$

where the exponent difference value ed=ea−eb. The exponent difference value ed can be represented in the binary format with a sign bit sed=logic [0,1], whereas sed=logic “1” for negative value and sed=logic “0” for positive value or equal value, and the absolute value|ed|in the binary format (ed_{q-1}ed_{q-2} . . . ed₁ed₀)b for |ed|=ed_{q-1}2^{q-1}+ed_{q-2}2^{q-2}+ . . . +ed₁2¹+ed₀2⁰, where ed₁ logic [0,1] for i=(q−1), . . . , 0. When ed is the positive or equal to zero number (ed≥0) with the sign bit sed=“0”, A's number range is larger or equal to the B's number range. The exponent of number A is then chosen to be the exponent for the addition/subtraction operation of the two floating-point numbers A and B. Meanwhile all the mantissa bits of the floating-point number B are down shifted (or shifted to the right) with the displacement number value |ed| represented by the binary code (ed_{q-1}ed_{q-2} . . . ed₁ed₀)b to align with the mantissa bits of number A for the addition/subtraction operation. When ed is the negative number (ed<0) with the sign bit sed=“1”, A's exponent is smaller than B's exponent. The exponent of number B is then chosen to be the exponent for the addition/subtraction operation of the two floating-point numbers A and B. Meanwhile all the mantissa bits of number A are down shifted with the displacement number value |ed| represented by the binary code (ed_{q-1}ed_{q-2} . . . ed₁ed₀)b to align with the mantissa bits of number B for the addition/subtraction operation.

Based on the above operational principle for the addition/subtraction operations of the two floating-point numbers in IEEE 754 format, the schematic diagram of addition and subtraction circuit device 200 of the invention in FIG. 2 comprises: (1) A/S Selection & Sign Logic circuit 240 respectively for the selection one of addition and subtraction operation (i.e., producing a “subtraction” bit) and the sign-bit operation for the resultant floating-point number; (2) Most Significant Bit circuit 210 for decoding the two most significant mantissa bits of the floating-point numbers A and B in IEEE 754 format; (3) Exponent Subtraction (ea−eb) circuit 220 for obtaining the sign bit (sed) and exponent difference bits (ed(0:q−1)) for a difference absolute value between the exponents of the two inputted floating-point numbers; (4) Mantissa Alignment circuit 221 for the mantissa bit alignment; (5) Addition/Subtraction circuits 222 for performing one of addition and subtraction operation according to the “subtraction” bit; (6) Exponent Sel/Add circuit 223 for obtaining the after-operation exponent bits es(0:q); and (7) IEEE 754 format conversion circuit 230.

The IEEE 754 format conversion circuit 230 comprises: (i) Leading Zero Detection circuit 231 for detecting the first/leading non-zero mantissa bit among mc(0:p) to output SL(0:p); (ii) LZ Shift Code Generation circuit 232 for encoding the outputs SL(0:p) of the Leading Zero Detection circuit 231 into the shifting binary code LZCₖ(0:q−1); (iii) Leading Zero Barrel Shifter circuit 233 for left-shifting the entire after-operation mantissa bits mc(0:p−1) to the first non-zero position according to the shifting binary code LZCₖ(0:q−1); (iv) Subnormal Barrel Shifter circuit 234 for right-shifting the entire mantissa bits ml(0:p−1) from the Leading Zero Barrel Shifter circuit 233 for the subnormal floating-point number format according to the outputs sb(0:q−1) of Exponent Adjustment circuit 235; (v) Exponent Adjustment circuit 235 for adjusting the exponent bits according to the after-operation exponent bits es(0:q) and the shifting binary code LZCₖ(0:q−1) to meet the IEEE 754 exponent format.

When the A/S Selection and Sign Logic circuit 240 is activated with the voltage signal V_{DD} for “Enb” at node 204, the Addition/Subtraction selection voltage signals (i.e., an external operator) for “A/S” at node 203 along with the voltage signals at node 201s for the sign bit “sa” of the floating-point number A and the voltage signals at node 202s for the sign bit “sb” of the floating-point number B are inputted to the circuit 240 to generate the voltage signals for the “subtraction” bit (i.e., an internal operator) that is used by Addition/Subtraction circuit 222 to perform addition or subtraction operation. After receiving the voltage signals for the “negation” bit/flag generated from the Addition/Subtraction circuit 222, the voltage signals for the sign bit “sc” of the resultant floating-point number C is then outputted at node 205s.

The input voltage signals for the floating-point number A in IEEE 754 format comprise the voltage signal for the sign bit “sa” at node 201s, the voltage signals for the exponent bits “(ea_{q-1}, . . . ,ea₀)b≡ea(0:q−1)” at nodes 201e, and the voltage signals at nodes 201m for the mantissa bits “(aₚ₋₂, . . . ,a₀)b≡a(0:p−2)”. The voltage input nodes 201s, 201e, and 201m form the voltage input nodes 201 for the floating-point number A in IEEE 754 format. While the input voltage signals for the floating-point number B in IEEE 754 format comprises the voltage signals for the sign bit “sb” at node 202s, the voltage signals at nodes 202e for the exponent bits “(eb_{q-1}, . . . ,eb₀)b≡eb(0:q−1)”, and the voltage signals at nodes 201m for the mantissa bits “(bₚ₋₂, . . . ,b₀)b≡b(0:p−2)”. The voltage input nodes 202s, 202e, and 202m form the voltage input nodes 202 for the floating-point number B in IEEE 754 format.

The voltage signals for the Most Significant mantissa bits “aₚ₋₁≡a(p−1)” and “bₚ₋₁≡b(p−1)” of the floating point numbers A and B are both obtained from the voltage signals for the two exponent (ea_{q-1}, . . . ,ea₀)b at nodes 201e and (eb_{q-1}, . . . ,eb₀)b at nodes 202e in the Most Significant Bit circuit 210. The voltage signals for a(p−1) and b(p−1) along with the voltage signals at nodes 201m for (aₚ₋₂, . . . ,a₀)b ≡a(0:p−2) and the voltage signals at nodes 202m for (bₚ₋₂, . . . , b₀)b≡b(0:p−2) form the voltage signals for the “p” mantissa bits of A and B, respectively. The Exponent Subtraction circuit 220 (ea−eb) with the input voltage signals at nodes 201e and 202e for the exponents (ea_{q-1}, . . . ,ea₀)b and (eb_{q-1}, . . . ,eb₀)b generates the voltage signals for the signed binary exponent difference, “sed” and ed(0:q−1). The voltage signals for “sed” and ed(0:q−1) are then fed into the Mantissa Alignment circuit 221 to parallel right-shift mantissas of A or B, whichever has the less exponent, to align the mantissa bits with each other in the Mantissa Alignment circuit 221 for addition/subtraction operation. After shifting mantissa bits of A or mantissa bits of B by the Mantissa Alignment circuit 221, the voltage signals for the aligned mantissa bits “ma(0:p−1)” of A and the aligned mantissa bits “mb(0:p−1)” of B, are then fed into the Addition/Subtraction circuit 222 for the binary addition/subtraction operation taking place. Note that the mantissa of the floating-point number operand with a larger exponent is shifting “zero” position, while the mantissa of the floating-point number operand with a less exponent is shifted to right (down-shifted mantissa) by the barrel-shifter circuit 520 with the shifting code ed(0:q−1) in the Mantissa Alignment circuit 221. Also note that the shifted mantissa bits for the floating-point number operand with a less exponent are truncated at the Least Significant Bit (LSB) of the “p” mantissa bits for the truncated mantissa accuracy of

$$\frac{1}{{2}^{p - 1}} .$$

Meanwhile voltage signals for the sign bit “sed” are fed into the Exponent Sel/Add circuit 223 to select the larger exponent of ea(0:q−1) and eb(0:q−1) to be added with the carry-over bit “mc(p)” from the Addition/Subtraction circuit 222 for generation of the after-operation exponent es(0:q). The voltage signals for the after-operation mantissa bits “mc(0:p)” from the Addition/Subtraction circuit 222 and the voltage signals for the after-operation exponent bits “es(0:q)” from the Exponent Sel/Add circuit 223 are then fed into the format conversion circuit 230 for converting the after-operation exponent bits “es(0:q)” and the after-operation mantissa bits “mc(0:p)” into the resultant floating-point number in the IEEE 754 format.

### BRIEF DESCRIPTION OF THE DRAWINGS

For a better understanding of the present invention and to show how it may be carried into effect, reference will now be made to the following drawings, which show the preferred embodiment of the present invention, in which:

FIG. 1 shows the conventional “m-bit” binary addition/subtraction circuit.

FIG. 2 shows a schematic diagram of a floating-point addition and subtraction circuit device 200 according to this invention.

FIG. 3 shows the circuit schematic diagram of Most Significant Bit circuit 210 that obtains the most significant mantissa bits for the two floating-point number operands in IEEE 754 format according to an embodiment of this invention.

FIG. 4 shows the circuit schematic diagram of a “q-bit” exponent subtraction circuit 220 for the exponents of the two floating-point number operands according to an embodiment of this invention.

FIG. 5A shows the circuit schematic diagram of mantissa alignment circuit 221 for right-shifting the mantissa of the floating-point number operand with a less exponent according to an embodiment of this invention.

FIG. 5B shows a circuit schematic diagram of barrel shifter circuit 520 according to an embodiment of this invention.

FIG. 6 shows the circuit schematic diagram of the addition/subtraction circuit 222 for the aligned mantissas of the two floating-point number operands according to an embodiment of this invention.

FIG. 7 shows the circuit schematic diagram of Exponent Sel & Add circuit 223 for the selection of larger exponent adding with the additional carry-over bit mc(p) according to an embodiment of this invention.

FIG. 8 shows the circuit schematic diagram of Leading Zero Detection circuit 231 for detecting the first non-zero bit of mantissa mc(0:p) according to an embodiment of this invention.

FIG. 9 shows the circuit schematic diagram of Shifting Code Generation circuit 232 for the generation of non-zero shifting code LZCₖ(0:q−1) according to an embodiment of this invention.

FIG. 10 shows the circuit schematic diagram of LZ Barrel Shifter circuit 233 for shifting up the after-operation mantissa bits for the IEEE 754 mantissa format according to an embodiment of this invention.

FIG. 11 shows the circuit schematic diagram of Subnormal Barrel Shifter circuit 234 for the IEEE 754 subnormal mantissa format according to an embodiment of this invention.

FIG. 12 shows the schematic diagram of exponent adjustment circuit 235 for the IEEE 754 exponent format according to an embodiment of this invention.

FIG. 13 shows a logic table 1310 for the “subtraction” bit and the sign bit (sc) of the resultant floating-point number in A/S selection & sign logic circuit 240 according to an embodiment of this invention.

FIG. 14 shows a schematic diagram of Addition/Subtraction selection and sign logic circuit 240 for the IEEE sign format according to an embodiment of this invention.

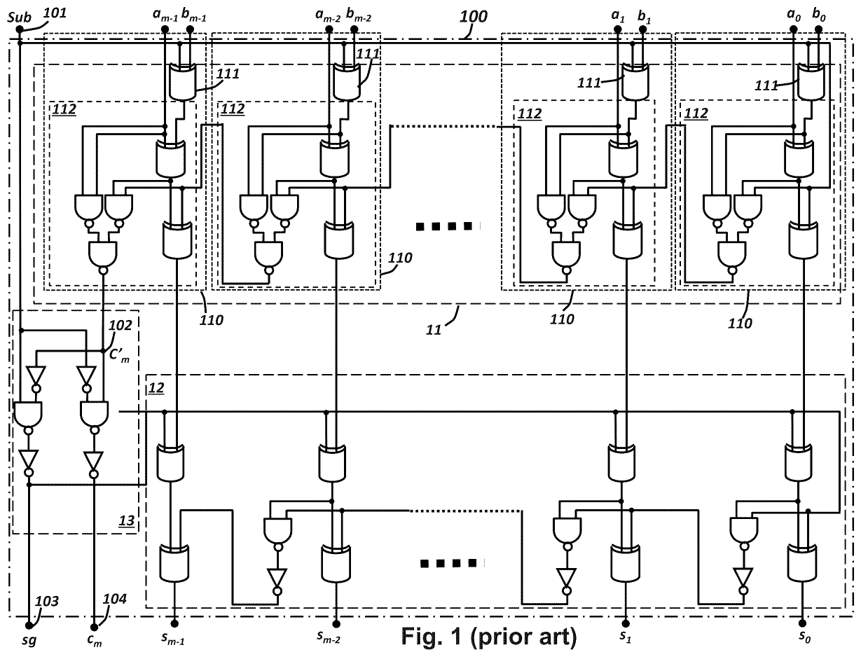

### DETAILED DESCRIPTION OF THE INVENTION

The following detailed description is meant to be illustrative only and not limiting. It is to be understood that the other circuit embodiment with floating-point number formats other than IEEE 754 format may be utilized such as manipulating mantissa bits and exponent bits of two floating-point numbers without departing from the scope of the present invention. Also, it is to be understood that the phraseology and terminology used herein are for the purpose of description and should not be regarded as limiting. Those of ordinary skill in the art will immediately realize that the embodiment of the present invention described herein in the context of methods and schematics are illustrative only and are not intended to be in any way limiting. Other embodiment of the present invention will readily suggest themselves to such skilled persons having the benefits of this disclosure.

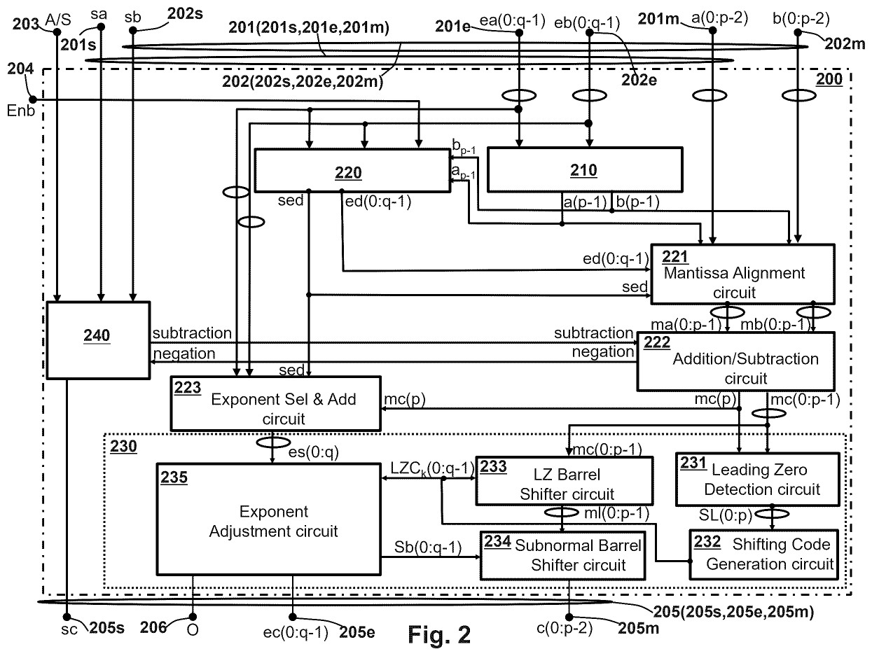

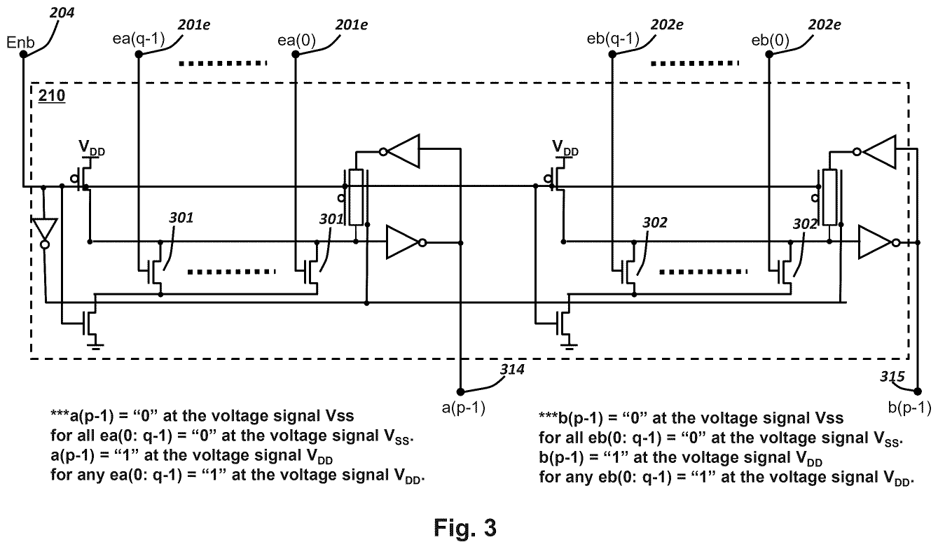

In the general embodiment, the circuit schematic diagram of addition and subtraction circuit device 200 is shown in FIG. 2 for the IEEE 754 (q+p)-bit floating-point number addition/subtraction. FIG. 3 shows the Most Significant Bit circuit 210 to generate the voltage signals for the most significant mantissa bits “a(p−1)” and “b(p−1)” from the input voltage signals at nodes 201e for the exponent bits “ea(0:q−1)” of the floating-point number A and the input voltage signals at nodes 202e for the exponent bits “eb(0:q−1)” of the floating-point number B. When the “Enb” voltage signal at node 204 is activated with the voltage signal “V_{DD}”, the NMOSTET devices 301 with their gates connected to the nodes 201e for the voltage signals of ea(0:q−1) and the NMOSTET devices 302 with their gates connected to the nodes 202e for the voltage signals of eb(0:q−1) output the voltage signals at node 314 and 315 for the most significant mantissa bits “a(p−1)” and “b(p−1)”, respectively. If the voltage signals for ea(0:q−1) are all inputted with V_{SS}, i. e., all digital “0”, the entire NMOSFET devices 301 are turned off to output the voltage signal V_{SS} (“0”) at node 314. For any of the voltage signals for ea(0:q−1) is inputted with V_{DD}, i. e., any digital “1”, the NMOSEFT device(s) 301 with the gate voltage of V_{DD} is/are turned on to output the voltage signal V_{DD} (“1”) at node 314. In the same way if the voltage signals for eb(0:q−1) are all inputted with V_{SS}, i. e., all digital “0”, the entire NMOSFET devices 302 are turned off to output the voltage signal V_{SS} (“0”) at node 315. For any of voltage signals for eb(0:q−1) is inputted with V_{DD}, i. e., any digital “1”, the NMOSEFT device(s) 302 with the gate voltage of V_{DD} is/are turned on to output the voltage signal V_{DD} (“1”) at node 315.

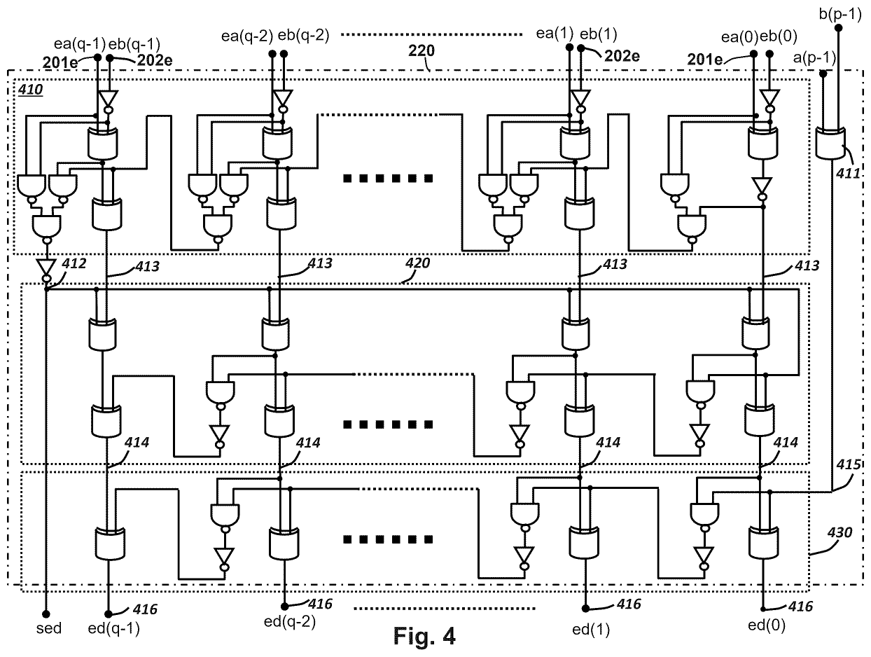

The Exponent Subtraction circuit 220 can be constructed with the q-bit binary subtraction circuit as shown in FIG. 4. In FIG. 4, the Exponent Subtraction circuit 220 comprises the first row of q-bit subtraction circuit 410, the second row of 2's complement conversion circuit 420, the third row of addition circuit 430 for the operation of one subnormal floating-point number operand with another normal floating-point number operand, and the XOR gate 411. The voltage signals at nodes 201e for ea(0:q−1) and at 202e for eb(0:q−1) are inputted into the subtraction circuit 410 to generate the voltage signal for the sign bit “sed” at node 412 to select the floating-point number operand with a less exponent and the voltage signals for the shifting code ed(0:q−1) at node 416 to shift down the mantissa positions of the floating-point number operand with a less exponent to align with the mantissa positions of the floating-point number operand with a larger exponent. If the voltage signal for the sign bit “sed” at node 412 is outputted with V_{SS} (“0”), it indicates the exponent of the floating-point number operand A is larger or equal to the exponent of the floating-point number B, i. e, “positive” or “zero” exponent difference. While the voltage signal for the sign bit “sed” at node 412 is outputted with V_{DD} (“1”) it indicates the exponent of the floating-point number operand A is smaller than the exponent of the floating-point number operand B, i. e., “negative” exponent difference. Accordingly for the negative exponent difference, the second row of 2's complement conversion circuit 420 converts the input voltage signals for the binary code at the output nodes 413 of the circuit 410 in the first row into the output voltage signals at the output nodes 414 for the 2's complement binary code. Otherwise for the “positive or “zero” exponent difference the output voltage signals at nodes 414 from the second row of 2's complement conversion circuit 420 remain the same as the input voltage signals from the output nodes 413 of the circuit 410 in the first row.

In the finite floating-point number binary representation, the subnormal floating-point numbers are represented with all “0”s binary exponent for the leading mantissa “0” and the normal floating-point numbers are represented with at least one non-zero binary exponent for the leading mantissa “1”, respectively. In order to align the mantissa positions for a subnormal floating-point number operand with the mantissa positions of a normal floating-point number operand for the addition/subtraction operation correctly, the mantissa positions of the subnormal floating-point number operand need to shift down one more mantissa position due to the different leading mantissa bits for “0” and “1”. Therefore the binary value (“1” for a(p−1)≠b(p−1) and “0” for a(p−1)=b(p−1)) of the output at node 415 of the XOR gate 411 is added with the outputs of the circuit 420 at the nodes 414 in the third row of the addition circuit 430 to obtain the correct shifting code ed(0:q−1) for the mantissa of a subnormal floating-point number operand to align with the mantissa of another normal floating-point number operand in the following subtraction/addition operation.

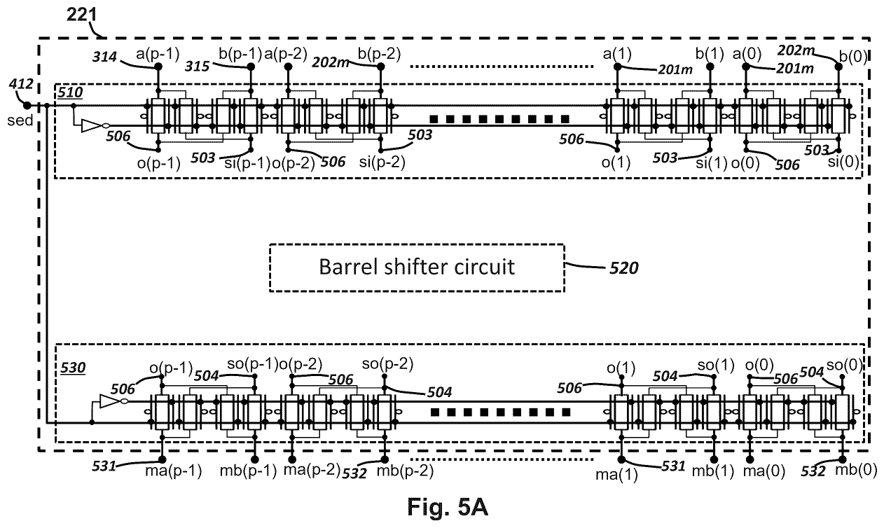

FIG. 5A shows the circuit schematic diagram of Mantissa Alignment circuit 221 in FIG. 2 for right-shifting the mantissa positions of the floating-point number operand with a less exponent to align the mantissa position of the floating-point number operand with a larger exponent. In FIG. 5A, the Mantissa Alignment circuit 221 includes a selection circuit 510 for selecting the less-exponent mantissa bits as si(0:p−1) fed into the inputs of barrel shifter circuit 520, a barrel shifter circuit 520 for parallel down-shifting inputted mantissa bits si(0:p−1) and filling empty bit(s) with “0” for the less-exponent mantissa bits so(0:p−1) and an operational order circuit 530 for placing back to the original operational order (always A's mantissa bits in the first operational place and B's mantissa bits in the second operational place, regardless whichever floating-point number has the less exponent). Referring to FIG. 5B, the barrel shifter circuit 520 contains 2p columns of transmission gates (Clm(0) to Clm(2p−1)), and the input nodes of the first p columns of transmission gates (Clm(0) to Clm(p−1)) are tied to the ground voltage V_{SS} (“0”) at node 501 for filling the down-shifted empty significant mantissa bits with “0s” at the output nodes 504 for the left portions of so(0:p−1). The voltage signals for the shifting code ed(0:q−1) at node 416 are inputted from the circuit 220 in FIG. 4 to control the right-shifting mantissa positions from the input nodes 503 for si(0:p−1) to the output nodes 504 for so(0:p−1). With the voltage signal V_{SS} at node 412 for sed (A>=B), the input voltage signals for a(0:p−1) are passed to the nodes 506 for o(0:p−1) in the selection circuit 510 and the input voltage signals for b(0:p−1) are passed to the input nodes 503 for si(0:p−1) of the barrel shifter circuit 520 for right-shifting the mantissa positions of the floating-point number B with a less exponent. Meanwhile with the voltage signal V_{SS} at node 412 for sed (A>=B), the voltage signals for o(0:p−1) through the nodes 506 are passed to the output nodes 531 for ma(0:p−1) and the voltage signals at the output nodes 504 for so(0:p−1) of the barrel shifter circuit 520 are passed to the output nodes 532 for mb(0:p−1) in the third row of operational order circuit 530. While with the voltage signal V_{DD} at node 412 for sed (A<B), the voltage signals for b(0:p−1) are passed to the output nodes 506 for o(0:p−1) in the selection circuit 510 and the voltage signals for a(0:p−1) are passed to the input nodes 503 for si(0:p−1) of the barrel shifter 520 for shifting the mantissa positions of the floating-point number A with a less exponent. Meanwhile with the voltage signal V_{DD} at node 412 for sed (A<B), the voltage signals for o(0:p−1) through the nodes 506 are passed to the output nodes 532 for mb(0:p−1) and the voltage signals at the output nodes 504 for so(0:p−1) of the barrel shifter circuit 520 are passed to the output nodes 531 for ma(0:p−1) in the third row of operational order circuit 530.

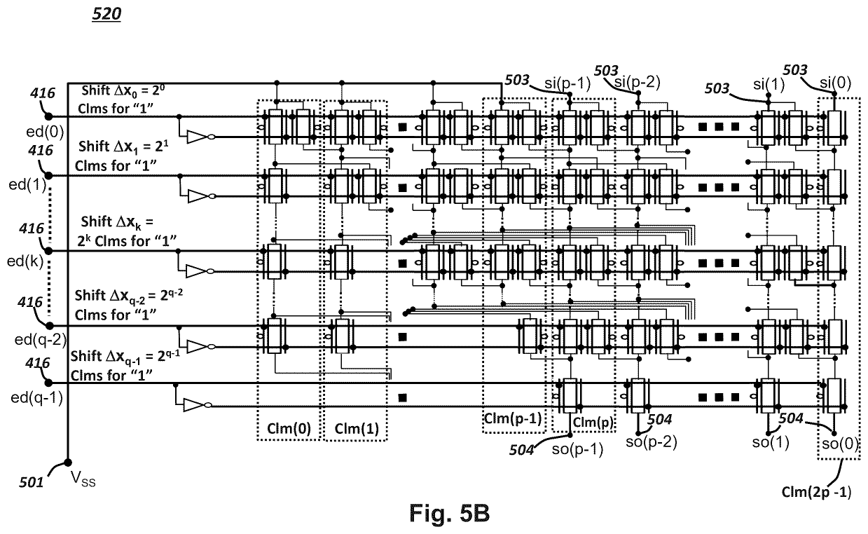

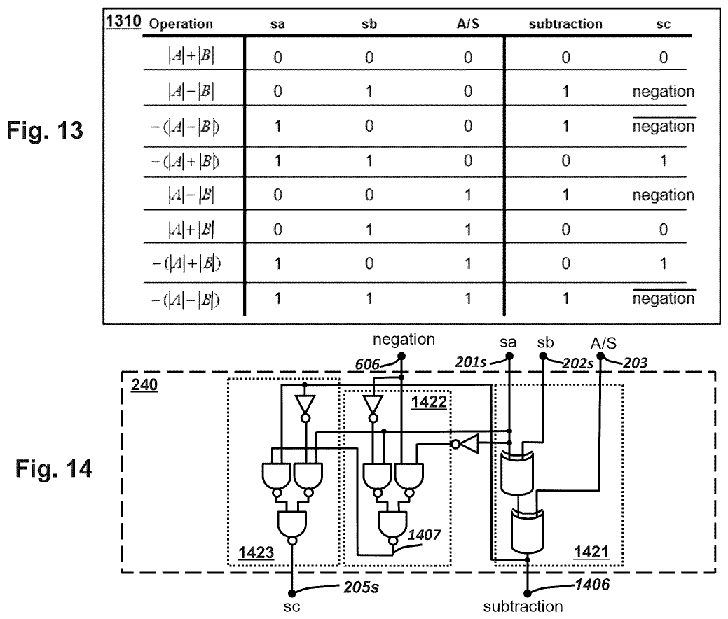

FIG. 6 shows the Addition/Subtraction circuit 222 in FIG. 2 comprises the p-bit addition/subtraction circuit 610, the p-bit 2's complement conversion circuit 620, and the carry-over/negation logic circuit 630. In FIG. 6, the voltage signals for the aligned mantissas ma(0:p−1) and mb(0:p−1) from the circuit 221 in FIG. 5A are inputted into the nodes 531 and the nodes 532, respectively. The voltage signal V_{DD}(“1”) and V_{SS} (“0”) at node 1406 in FIG. 14 for “subtraction” bit (i.e., an internal operator) inputted from the A/S selection & Sign Logic circuit 240 respectively selects the subtraction operation, i. e., the subtraction operation for the aligned mantissas (ma(0:p−1)−mb(0:p−1)) and the addition operation, i. e., the addition operation for the aligned mantissas (ma(0:p−1)+mb(0:p−1)), respectively. After the subtraction/addition operation, the voltage signals are then outputted at the nodes 604 for mc(0:p−1) and the voltage signals for the carry-over bit mc(p) are outputted at node 605. The voltage signal V_{DD} (“1”) for mc(p) at node 605 indicates the additional carry-over after the addition operation. Otherwise the voltage signal V_{SS} (“0”) for mc(p) indicates no additional carry-over for the addition operation. Meanwhile the voltage signal V_{DD} (“1”) for “negation” bit/flag at node 606 indicates negative, i. e., ma((0:p−1)<mb(0:p−1), for the subtraction operation. Otherwise the voltage signal V_{SS} (“0”) for “negation” bit/flag at node 606 indicates positive or zero, i. e., ma((0:p−1)≥mb(0:p−1) for the subtraction operation. The voltage signals at node 606 for the “negation” bit is then fed into the A/S selection & Sign Logic circuit 240 to obtain the voltage signals for the sign “sc” of the resultant floating-point number C at node 205s in FIG. 2.

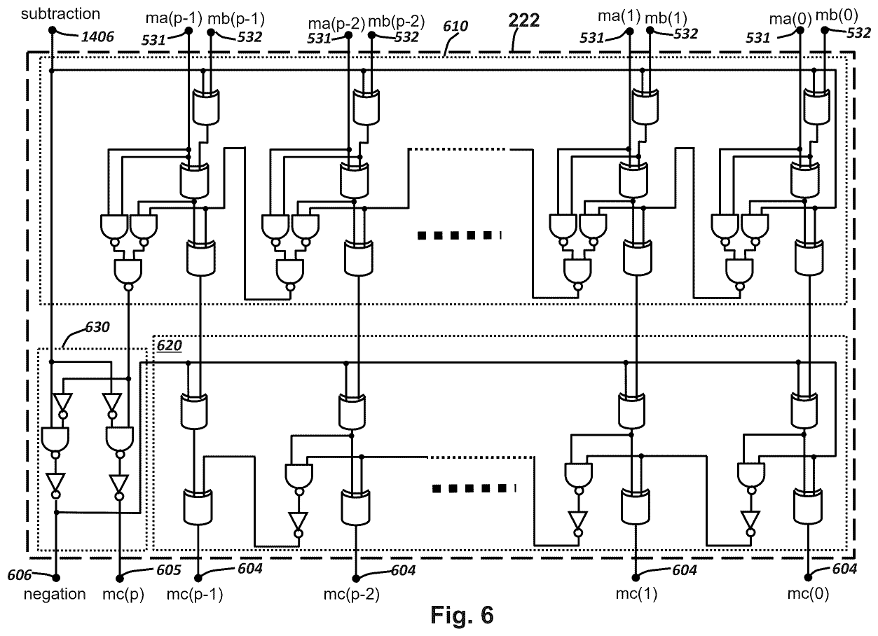

FIG. 7 shows the circuit schematic of Exponent Sel & Add circuit 223 according to an embodiment of the invention. The Exponent Sel & Add circuit 223 comprises a row of transmission gates 710 for the selection of the larger exponent of ea(0:q−1) at the input nodes 201e and eb(0:q−1) at the input nodes 202e by the selection control voltage signals for sed and the addition circuit 720 for adding the carry-over bit mc(p) at node 605 and the selected larger exponent to produce the after-operation exponent es(0:q) at nodes 705 and 206. The after-operation exponent es(0:q) at nodes 705 and 206 in FIG. 7 and the after-operation mantissa mc(0:p) at nodes 604 and 605 in FIG. 6 represent the exponent bits and mantissa bits for the after-operation floating-point number without the sign bit. The after-operation exponent es(0:q) and the after-operation mantissa mc(0:p) are then converted by the IEEE 754 format conversion circuit 230 in FIG. 2.

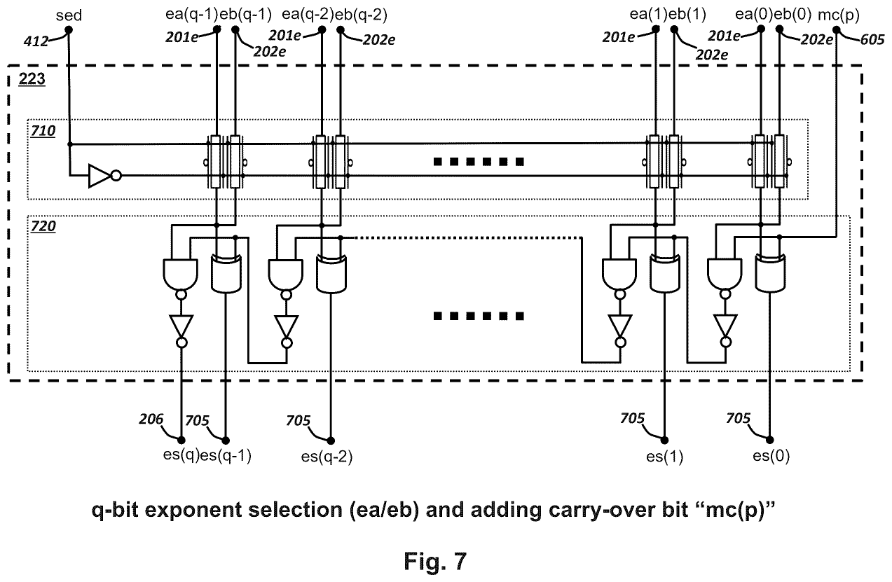

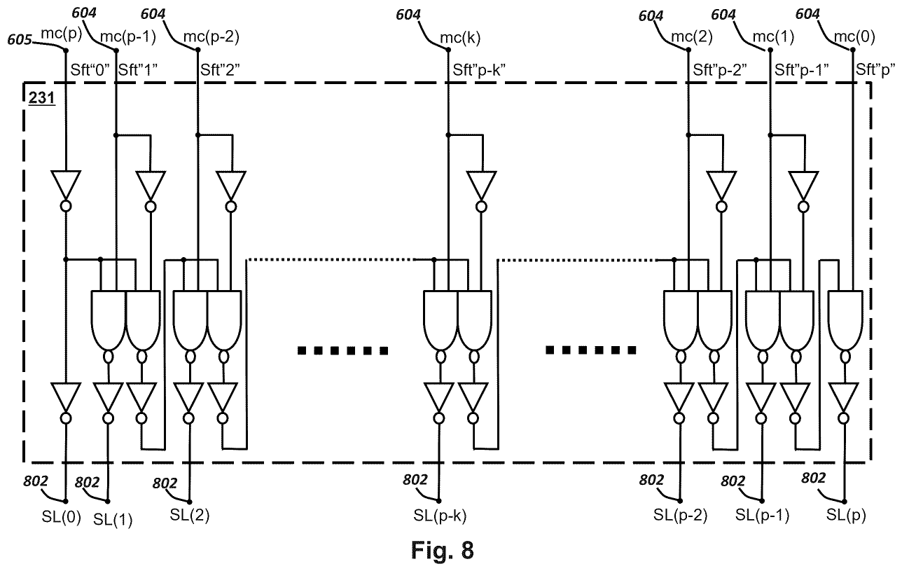

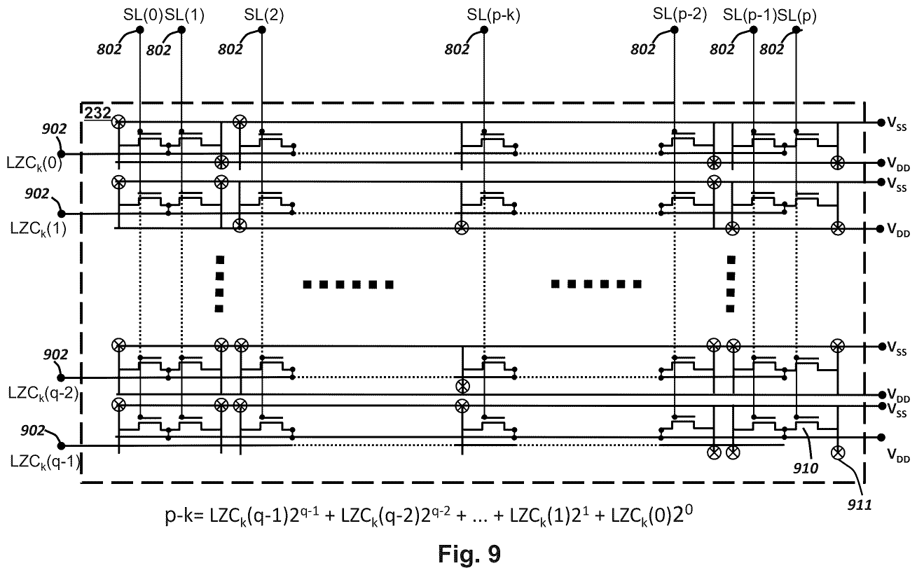

For the IEEE 754 format conversion circuit 230, FIG. 8 shows a schematic diagram of the Leading Zero Detection circuit 231 detecting the first/leading nonzero mantissa bit among mc(0:p) relative to the MSB mc(p). In FIG. 8, the voltage signals for mc(0:p) including the carry-over bit mc(p) are inputted at nodes 604 and 605. When the voltage signal V_{DD} for the first non-zero bit mc(k) among mc(0:p) relative to the MSB mc(p) is detected, the circuit 231 outputs the voltage signal V_{DD} (“1”) for the correspondent column SL(p-k) with the voltage signal V_{SS} (“0”) for all the other columns SL(n) at the output nodes 802, where n=0~p and n≠(p−k). The voltage signals for SL(0:p) are then fed into the LZ Shifting Code Generation circuit 232 in FIG. 9 to generate the voltage signals for the shifting code LZCₖ(0:q−1) to shift up the mantissa bits for mc(0:p−1) to the first non-zero leading mantissa position (i.e., ml(p−1)) in Leading Zero Shifter circuit 233 in FIG. 10. Note that in FIG. 9, the Shifting Code generation circuit 232 is a ROM (Read Only Memory) array comprising multiple ROM cells, where each metal contact 911 is predefined and used to connect the drain active area of its corresponding transistor 910 to one of two metal lines applied with the voltages V_{DD} or V_{SS}, i.e., multiple predefined binary codes being stored in the multiple ROM cells in advance. The only selected wordline for SL(p−k) among the input nodes 802 is turned on with V_{DD} to output the voltage signals of the ROM code LZCₖ(0:q−1) for the value (p−k)=LZCₖ(q−1)2^{q-1}+LZCₖ(q−2)2^{q-2}+ . . . +LZCₖ(1)2¹+LZCₖ(0)2⁰ at nodes 902. For example, if mc(p−2)=“1” and mc(p)=mc(p−1)=“0”, mc(p−2) is called the leading/first nonzero bit among mc(0:p), and SL(2)=“1” with the other SL(k)=“0”, for k=0, 1, 3, . . . ,p, is obtained. Then the voltage signals for the shifting code LZCₖ(0:q−1)=(00 . . . 10)b output at the bitline nodes 902 in the circuit 232 shown in FIG. 9.

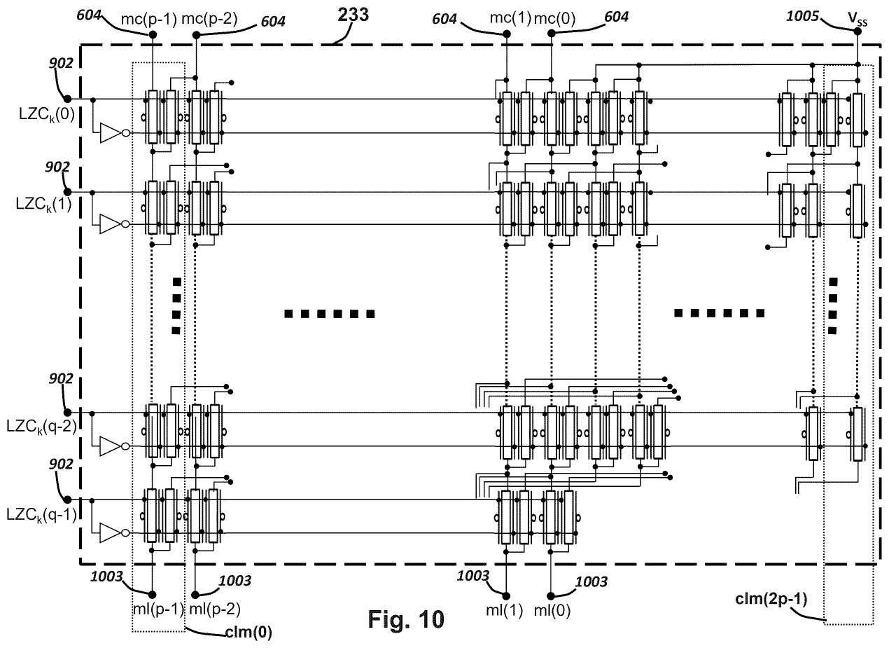

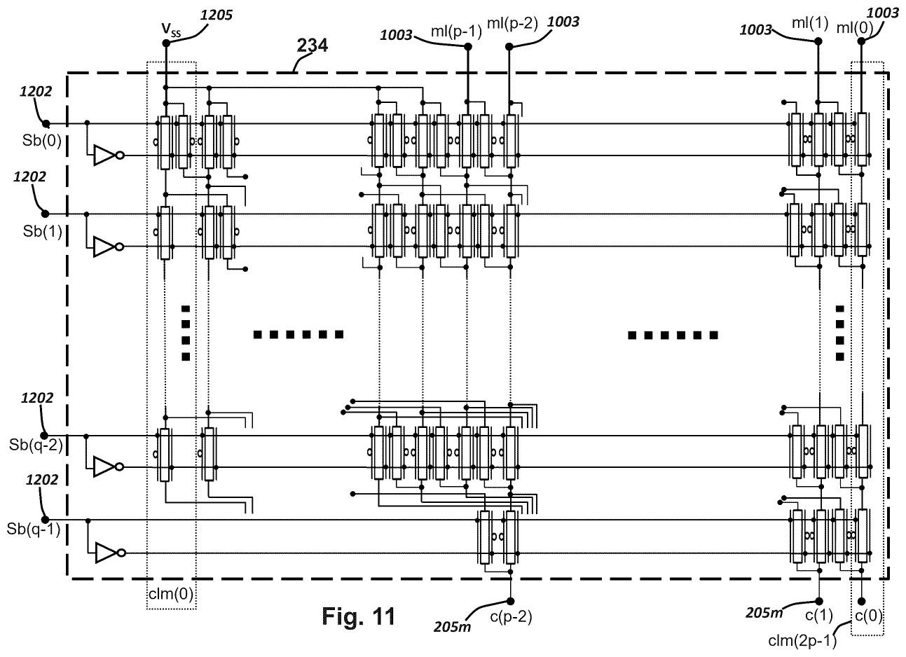

FIG. 10 shows a schematic diagram of a barrel-shifter circuit 233 for parallel left-shifting mc(0:p−1) at the input nodes 604 to ml(0:p−1) at the output nodes 1003 for the first non-zero leading mantissa position (i.e., ml(p−1)) by the shifting code LZCₖ(0:q−1) at nodes 902 from the outputs of the LZ Shifting Code Generation circuit 232 in FIG. 9. The barrel shifter circuit 233 contains 2p columns of transmission gates (Clm(0) to Clm(2p−1)), and the input nodes of the second p columns (Clm(p) to Clm(2p−1)) are tied to the ground voltage V_{SS} (“0”) at node 1005. The voltage signals for ml(0:p−1) are then fed into the input nodes 1003 of the subnormal barrel shifter circuit 234 in FIG. 11. In FIG. 11, the subnormal barrel shifter circuit 234 parallel shifts down (or right) the mantissa bits ml(0:p−1) with the leading subnormal empty mantissa bits filled with “0s” to the output nodes 205m for c(0:p−2) according to the shifting codes Sb(0:q−1) at nodes 1202 generated from the Exponent Adjustment circuit 235 in FIG. 12. The subnormal barrel shifter circuit 234 contains 2p columns of transmission gates (Clm(0) to Clm(2p−1)), and the input nodes of the first p columns (Clm(0) to Clm(p−1)) are tied to the ground voltage V_{SS} (“0”) at node 1205. While the subnormal barrel shifter circuit 234 in FIG. 11 shifts the mantissa positions of the normal floating-point number for “zero” position with the shifting codes Sb(0:q−1)=(0 . . . 0)b to the output nodes 205m for c(0:p−2). That is, the voltage signals for ml(0:p−2) at node 1003 are directly passed to the voltage signals for c(0:p−2) at nodes 205m. The voltage signals for the subnormal shifting codes Sb(0:q−1) are generated from the Exponent Adjustment circuit 235 in FIG. 12. It should be noted that the above barrel shifter circuits 520, 233 and 234 in FIGS. 5B and 10-11 are utilized as embodiment and not limitations of the invention. In actual implementations, each of the above barrel shifter circuits 520, 233 and 234 can be replaced with any other types of barrel shifter, such as a crossbar barrel shifter and a barrel shifter implemented as a cascade of parallel multiplexers as long as the same results can be reached, and this also falls in the scope of the invention.

In FIG. 12, the Exponent Adjustment circuit 235 comprises (1) the “add-one” circuit 1210 to add the shifting code LZCₖ(0:q−1) with a number of one;(2) the subtraction circuit 1220 for the after-operation exponent subtracting the output (LZCₖ(0:q−1)+(0 . . . 1)b) of the “add-one” circuit 1210 from the after-operation exponent (es(0:q−1); (3) the add-one circuit 1230 to add number one back to compensate the extra subtraction number one for the normal floating-point number, i. e., producing [es(0:q−1)−(LZCₖ(0:q−1)+(0 . . . 1)b)+(0 . . . 1)b] at nodes 1231; (4) the logic circuit 1240 to generate the voltage signals for the resultant exponent ec(0:q−1) at node 205e and the voltage signals for the shifting code Sb(0:q−1) at node 1202. In the logic circuit 1240, the voltage signals for the exponent sign “esg” at node 1221 is applied to determine whether the after-operation floating-point number is a subnormal floating-point number or a normal floating-point number. The voltage signal V_{DD} for the exponent sign “esg” at node 1221 indicates the floating-number is a subnormal floating-point number with all “0s” for the exponent bits. Therefore the output voltage signals for the exponent ec(0:q−1) at nodes 205e are set to the voltage signal V_{SS} (“0”). Meanwhile the voltage signals for the “non-zero” subnormal shifting code Sb(0:q−1) at nodes 1202 generated from the output nodes 1222 of the subtraction circuit 1220 are applied to the Subnormal Shifter circuit 234 in FIG. 11 to down-shift (or right-shift) the subnormal mantissa bits with the leading empty mantissa bit(s) filled with “0(s)”. On the other hand the voltage signal V_{SS} for the exponent sign “esg” at node 1221 indicates the floating-number is a normal floating-point number with a non-zero exponent. The outputs at nodes 1222 from the subtraction circuit 1220 are fed into the add-one circuit 1230 to add the number one back to compensate the extra subtraction of number one for the correct “non-zero” exponent ec(0:q−1) of a normal floating-point number. Meanwhile the “zero” shifting code for Sb(0:q−1)=(0 . . . 0)b is generated by the logic circuit 1240 with the voltage signal V_{SS} (“0”) for “esg” at node 1221 to shift no position for ml(0:p−2) directly passed to c(0:p−2) at nodes 205m in the subnormal barrel shifter circuit 234 in FIG. 11. Note that the voltage signals for the most significant exponent bit es(q) from the Exponent Sel & Add 223 in FIG. 7 are directly passed to the overflow node O 206 for the flag sign of the overflow situation.

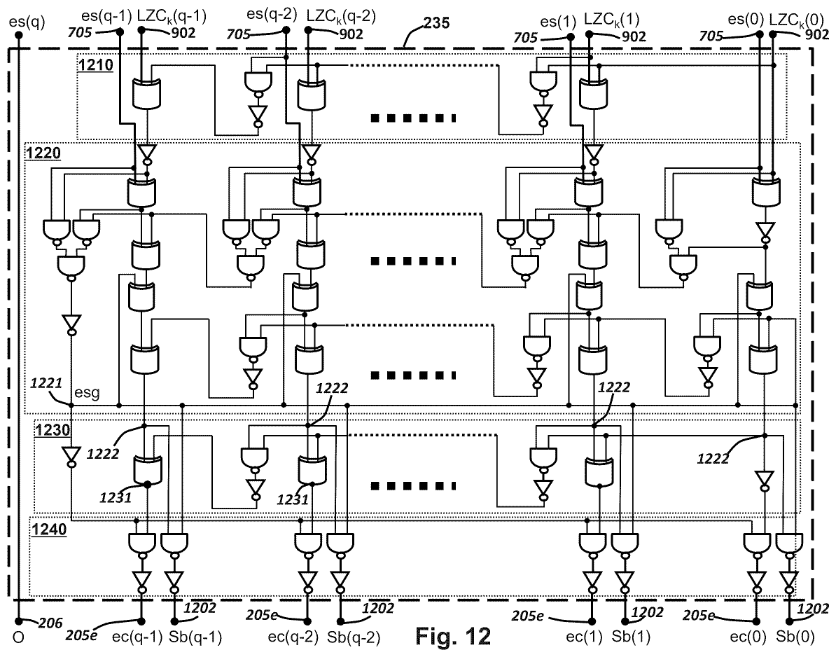

FIGS. 13 and 14 respectively show the logic table 1310 and the correspondent Addition/Subtraction selection and Sign Logic circuit 240. The equations for the addition/subtraction operation of absolute values of the floating-point number A and the floating-point number B are defined in the first column of the logic table 1310. The first row of the table 1310 shows the inputs: the sign bits “sa” and “sb” for the two floating-point numbers A and B, “A/S” bit (i.e., an external operator) for the selection one of Addition and Subtraction, the “subtraction” bit (i.e., an internal operator) for the Addition/Subtraction circuit 222 to perform the subtraction or addition for the absolute values of the two floating-point number operands A and B and the sign bit “sc” for the resultant floating-point number C. The signs of the floating-point numbers A, B and C, “sa”, “sb”, and “sc” are defined as “1” for negative number and “0” for positive or equal-to-zero number and “A/S” is defined as “0” for the addition operation and “1” for subtraction operation. The logic values in the last column for “sc” contain the logic values of “negation” bit and “inverse negation” bit, where “negation” bit is the negative value sign for the after-operation floating-point number after the addition/subtraction circuit 222 for a difference between the two aligned p-bit mantissas ma(0:(p−1)) and mb(0:(p−1)) for the absolute values of the floating-point number operands A and B. The sign “negation” for the after-operation floating-point number is defined as “0” for positive and equal-to-zero value and “1” for negative value from the Addition/Subtraction circuit 222, respectively.

The corresponding A/S Selection & Sign Logic circuit 240 for the logic table 1310 is shown in FIG. 14. The A/S Selection & Sign Logic circuit 240 receives the input voltage signals at nodes 201s, 202s, and 203 for sa, sb, and A/S in FIG. 2. The output voltage signals at node 1406 for “subtraction” (corresponding to the logic values in the 5^{th} column of table 1310) are obtained from the logic circuit 1421 from the input voltage signals for sa, sb, and A/S according to the logic values shown in the 2^{nd} 3^{rd}, and 4^{th} columns of the logic table 1310. The voltage signals at node 1406 for “subtraction” bit are then fed to the Addition/Subtraction circuit 222 to carry out the addition or subtraction for the two aligned mantissa bits ma(0:p−1) and mb(0:p−1) for the absolute value of the floating-point number A and the absolute value of the floating-point number B. Meanwhile the input voltage signals for “negation” bit from the output of Addition/Subtraction circuit 222 are fed to the logic circuit 1422. The logic circuit 1422 outputs the voltage signals at node1407 in response to “negation” bit or “inverse negation” bit selected by the control voltage signals for “sa” correspondent to the logic values in the 2^{nd} column of the logic table 1310. Therefore the output signals for the sign “sc” of the resultant floating-point number C in logic circuit 1423 are outputted at node 205s according to either the voltage signals for sa correspondent to the logic values in the 2^{nd} column of logic table 1310 or the voltage signals for “negation/inverse negation” correspondent to the logic values in the 5^{th} column of logic table 1310 selected by the control voltage signals for “subtraction” bit at node1406 corresponding to the logic values shown in the 4^{th} column of the logic table 1310, respectively.

In one embodiment, the addition and subtraction circuit device for the 16-bit floating-point numbers with IEEE 754 format has been designed and fabricated with a foundry's 40 nm CMOS process technology. The circuit device is verified for the resultant floating-point number from two floating-point number addition/subtraction operation with the accuracy round to the nearest floating-point number for the IEEE 754 16-bit format and the operational time for the circuit device is around 0.6 nano-seconds according to the circuit post-simulation with circuit RC loading. The average peak current for various floating number operations is around tens of mA with the high voltage supply of V_{DD}=1.2 V.

The aforementioned description of the preferred embodiment of the invention has been presented for purposes of illustration and description. It is not intended to be exhaustive or to limit the invention to the precise form or to exemplary embodiment disclosed. Accordingly, the description should be regarded as illustrative rather than restrictive. The embodiment is chosen and described in order to best explain the principles of the invention and its best mode practical application, thereby to enable persons skilled in the art to understand the invention for various embodiment and with various modifications as are suited to the particular use or implementation contemplated. It is intended that the scope of the invention be defined by the claims appended hereto and their equivalents in which all terms are meant in their broadest reasonable sense unless otherwise indicated. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiment of the invention. It should be appreciated that variations may be made in the embodiment described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A floating-point arithmetic device for performing an arithmetic operation on a first operand and a second operand based on an external operator indicating one of addition and subtraction to generate a resultant number, wherein each of the first operand, the second operand and the resultant number is a binary floating-point number and consists of a sign bit, a q-bit exponent and a p-bit mantissa, the device comprising:
an exponent subtraction circuit for producing a first sign bit and an exponent difference according a difference between the q-bit exponents of the first and the second operands;
an exponent comnputation circuit coupled to the exponent subtraction circuit for selecting a larger exponent from the q-bit exponents of the first and the second operands according to the first sign bit and for generating an intermediate (q±1)-bit exponent according to the larger exponent;
a mantissa computation circuit coupled to the exponent subtraction circuit for selecting a less exponent from the q-bit exponents of the first and the second operands according to the first sign bit, right-shifting one of the p-bit mantissas of the first and the second operands corresponding to the less exponent according to a first q-bit shift binary code to generate a right-shifted p-bit mantissa, and performing one of addition and subtraction on the right-shifted p-bit mantissa and the other p-bit mantissa of the p-bit mantissas of the first and the second operands according to an internal operator associated with the external operator and the sign bits of the first and the second operands to generate an intermediate (p+1)-bit mantissa, wherein the first q-bit shift binary code equivalently represents the exponent difference; and
a conversion circuit coupled to the exponent computation circuit and the mantissa computation circuit for respectively converting the intermediate (q−+1)-bit exponent and the intermediate (p−1)-bit mantissa into the q-bit exponent and the p-bit mantissa of the resultant number.

2. The device according to claim 1, further comprising:
a sign and operator logic circuit coupled to the mantissa computation circuit for producing the sign bit of the resultant number and the internal operator according to the external operator, the sign bits of the first and the second operands and a negation flag indicating whether an absolute value of the right-shifted p-bit mantissa is less than an absolute value of the other p-bit mantissa of the p-bit mantissas of the first and the second operands.

3. The device according to claim 2, wherein the sign and operator logic circuit comprises:
two XOR gate devices connected in series and having three inputs receiving the external operator, the sign bits of the first and the second operands to generate the internal operator.

4. The device according to claim 1, wherein the exponent computation circuit comprises:
a first addition circuit for adding a most significant bit (MSB) of the intermediate (p+1)-bit mantissa and the larger exponent to generate the intermediate (q+1)-bit exponent.

5. The device according to claim 1, wherein the exponent subtraction circuit comprises:
a first subtraction circuit for subtracting the q-bit exponent of the second operand from the q-bit exponent of the first operand to generate a signed intermediate exponent difference;
a XOR gate device having two inputs receiving MSBs of the p-bit mantissas of the first and the second operands to produce an output bit; and
a second addition circuit for adding the output bit and the signed intermediate exponent difference to produce the first sign bit and the exponent difference.

6. The device according to claim 1, wherein the mantissa computation circuit comprises:
a first barrel shifter circuit for parallel right-shifting the one of the p-bit mantissas of the first and the second operands corresponding to the less exponent by the first q-bit shift binary code to output the right-shifted p-bit mantissa.

7. The device according to claim 1, wherein the mantissa computation circuit comprises:
an arithmetic circuit for performing the one of addition and subtraction on the right-shifted p-bit mantissa and the other p-bit mantissa of the p-bit mantissas of the first and the second operands according to the internal operator to generate the intermediate (p+1)-bit mantissa.

8. The device according to claim 1, wherein a MSB of the intermediate (q+1)-bit exponent indicates whether the resultant number is out of a numeric representation range.

9. The device according to claim 1, wherein the conversion circuit is configured to identify a leading non-zero bit position among the intermediate (p+1)-bit mantissa relative to a MSB position of the intermediate (p+1)-bit mantissa, transform the leading non-zero bit position into a second q-bit shift binary code, parallel left-shift p lower significant bits of the intermediate (p+1)-bit mantissa according to the second q-bit shift binary code to produce an intermediate p-bit mantissa, and produce the q-bit exponent of the resultant number according to a difference between the intermediate (q+1)-bit exponent and the second q-bit shift binary code.

10. The device according to claim 9, wherein the conversion circuit comprises:
a third addition circuit for adding a number value one to the second q-bit shift binary code to generate a first q-bit sum binary code;
a second subtraction circuit for subtracting the first q-bit sum binary code from the intermediate (q+1)-bit exponent to output a second sign bit esg and a q-bit difference binary code;
a fourth addition circuit for adding a number value one to the q-bit difference binary code to generate a second q-bit sum binary code; and
a logic circuit coupled to the second subtraction circuit and the fourth addition circuit for producing the q-bit exponent of the resultant number and a third q-bit shift binary code;
wherein if the second sign bit esg is equal to 1, the logic circuit sets the q-bit exponent of the resultant number to a binary code of a zero vector and sets the third q-bit shift binary code to the q-bit difference binary code; and
wherein if the second sign bit esg is equal to 0, the logic circuit sets the q-bit exponent of the resultant number to the second q-bit sum binary code and sets the third q-bit shift binary code to a binary code of a zero vector

11. The device according to claim 10, wherein the conversion circuit comprises:
a second barrel shifter circuit for parallel shifting the p lower significant bits of the intermediate (p+1)-bit mantissa to the left by the second q-bit shift binary code to output the intermediate p-bit mantissa; and
a third barrel shifter circuit for parallel shifting the intermediate p-bit mantissa to the right by the third q-bit shift binary code to output the p-bit mantissa of the resultant number.

12. The device according to claim 11, wherein the conversion circuit comprises:
a detection circuit coupled to the mantissa computation circuit and having (p+1) output terminals for identifying the leading non-zero bit position among the intermediate (p+1)-bit mantissa relative to the MSB position of the intermediate (p+1)-bit mantissa to generate an activated bit and p de-activated bits at the (p+1) output terminals; and
a ROM array for receiving the activated bit and p de-activated bits to output the second q-bit shift binary code.

13. The device according to claim 12, wherein the detection circuit comprises:
a number (p−1) of logic blocks and a logic component connected in series for respectively checking a (p−1)th bit to a 0^{th} bit of the intermediate (p+1)-bit mantissa to provide data for an output terminal (1) to an output terminal (p) of the (p+1) output terminals;
wherein the MSB of the intermediate (p+1)-bit mantissa is provided for an output terminal (0) of the (p+1) output terminals, and the data provided at the (p+1) output terminals form the activated bit and the p de-activated bits.

14. The device according to claim 12, wherein the ROM array comprises:
multiple ROM cells arranged in rows and columns configuration and storing multiple predefined binary codes in advance;
a number (p+1) of word lines respectively connected to the (p+1) output terminals of the detection circuit; and
a number q of bit lines coupled to the second barrel shifter circuit; wherein when one of the number (p+1) of word lines is enabled by the activated bit, a corresponding row of ROM cells are turned on to output the second q-bit shift binary code at the number q of bit lines.

15. An operating method of a floating-point arithmetic device that performs an arithmetic operation on a first operand and a second operand based on an external operator indicating one of addition and subtraction to generate a resultant number, the floating-point arithmetic device comprising a first barrel shifter circuit and a conversion circuit, wherein each of the first operand, the second operand and the resultant number is a binary floating-point number and consists of a sign bit, a q-bit exponent and a p-bit mantissa, the method comprising the steps of:
calculating a difference between the q-bit exponents of the first and the second operands to obtain a first sign bit and an exponent difference;
right-shifting one of the p-bit mantissas of the first and the second operands corresponding to a less exponent using the first barrel shifter circuit by a first q-bit shift binary code to obtain a right-shifted p-bit mantissa, wherein the first q-bit shift binary code equivalently represents the exponent difference and the less exponent is selected from the q-bit exponents of the first and the second operands according to the first sign bit;
performing one of addition and subtraction on the right-shifted p-bit mantissa and the other p-bit mantissa of the p-bit mantissas of the first and the second operands according to an internal operator associated with the external operator and the sign bits of the first and the second operands to obtain a first intermediate (p+1)-bit mantissa;
obtaining an intermediate (q+1)-bit exponent according to a larger exponent that is selected from the q-bit exponents of the first and the second operands based on the first sign bit; and
respectively converting the intermediate (q+1)-bit exponent and the intermediate (p+1)-bit mantissa by the conversion circuit into the q-bit exponent and the p-bit mantissa of the resultant number.

16. The method according to claim 15, further comprising:
obtaining the sign bit of the resultant number and the internal operator according to the external operator, the sign bits of the first and the second operands and a negation flag indicating whether an absolute value of the right-shifted p-bit mantissa is less than an absolute value of the other p-bit mantissa of the p-bit mantissas of the first and the second operands prior to the step of performing.

17. The method according to claim 16, wherein the step of obtaining the sign bit of the resultant number and the internal operator comprises:
performing a XOR operation over the external operator and the sign bits of the first and the second operands to obtain the internal operator; and
obtaining the sign bit of the resultant number according to the sign bit of the first operand, the negation flag and the internal operator.

18. The method according to claim 15, wherein the step of obtaining the intermediate (q+1)-bit exponent comprises:
adding a most significant bit (MSB) of the intermediate (p+1)-bit mantissa and the larger exponent to obtain the intermediate (q+1)-bit exponent.

19. The method according to claim 15, wherein the step of calculating comprises:
subtracting the q-bit exponent of the second operand from the q-bit exponent of the first operand to obtain a signed intermediate exponent difference;
performing a XOR operation over MSBs of the p-bit mantissas of the first and the second operands to obtain an output bit; and
adding the output bit to the signed intermediate exponent difference to obtain the first sign bit and the exponent difference.

20. The method according to claim 15, wherein the step of respectively converting comprises:
identifying a leading non-zero bit position among the intermediate (p+1)-bit mantissa relative to a MSB position of the intermediate (p+1)-bit mantissa by a detection circuit;
transforming the leading non-zero bit position by a ROM array into a second q-bit shift binary code; and
parallel left-shifting p lower significant bits of the intermediate (p+1)-bit mantissa using a second barrel shifter circuit by the second q-bit shift binary code to produce an intermediate p-bit mantissa;
wherein the conversion circuit comprises the detection circuit, the ROM array and the second barrel shifter circuit.

21. The method according to claim 20, wherein the step of respectively converting further comprises:
obtaining the q-bit exponent of the resultant number according to a difference between the intermediate (q+1)-bit exponent and the second q-bit shift binary code after the steps of identifying and transforming.

22. The method according to claim 21, wherein the step of obtaining the q-bit exponent of the resultant number comprises:
adding a number value one to the second q-bit shift binary code to obtain a first q-bit sum binary code;
subtracting the first q-bit sum binary code from the intermediate (q+1)-bit exponent to obtain a second sign bit esg and a q-bit difference binary code;
adding a number value one to the q-bit difference binary code to obtain a second q-bit sum binary code;
if the second sign bit esg is equal to 1, setting the q-bit exponent of the resultant number to a binary code of a zero vector and setting a third q-bit shift binary code to the q-bit difference binary code; and
if the second sign bit esg is equal to 0, setting the q-bit exponent of the resultant number to the second q-bit sum binary code and setting the third q-bit shift binary code to a binary code of a zero vector.

23. The method according to claim 22, wherein the step of respectively converting further comprises:
parallel shifting the intermediate p-bit mantissa to the right by the third q-bit shift binary code by a third barrel shifter circuit to output the p-bit mantissa of the resultant number after the step of parallel left-shifting the p lower significant bits of the intermediate (p+1)-bit mantissa;
wherein the conversion circuit further comprises the third barrel shifter circuit.

24. The method according to claim 20, wherein the step of identifying comprises:
identifying the leading non-zero bit position among the intermediate (p+1)-bit mantissa relative to the MSB position of the intermediate (p+1)-bit mantissa by the detection circuit to obtain an activated bit and p de-activated bits;
wherein the detection circuit comprises a number (p−1) of logic blocks and a logic component connected in series.

25. The method according to claim 24, wherein the step of transforming comprises:
applying the activated bit and the p de-activated bits to a number (p+1) of word lines of the ROM array; and
when one of the number (p+1) of word lines is enabled by the activated signal, turning on a corresponding row of ROM cells so as to output the second q-bit shift binary code by a number q of bit lines in the ROM array;
wherein the ROM array comprises multiple ROM cells that are arranged in rows and columns configuration and store predefined binary codes in advance.

26. The method according to claim 15, wherein a MSB of the intermediate (q+1)-bit exponent indicates whether the resultant number is out of a numeric representation range.
